(19) United States
(12) Patent Application Publication
(10) Pub. No.: US 2011/0267570 A1
(43) Pub. Date: Nov. 3, 2011

(54) ELECTRO-OPTICAL DEVICE

(75) Inventors: Yuka Saito, Saitama (JP); Yuichi Kato, Tokyo (JP)

(73) Assignee: CITIZEN HOLDINGS CO., LTD., Nishitokyo-shi (JP)

(21) Appl. No.: 12/680,761

(22) PCT Filed: Feb. 26, 2009
(86) PCT No.: PCT/JP2009/054096

§ 371 Date: Mar. 30, 2010

(30) Foreign Application Priority Data
Mar. 3, 2008 (JP) 2008-052011

(51) Int. Cl. G02F 1/1343; G02F 1/03

(52) U.S. Cl. 349/139; 359/245

(57) ABSTRACT

An object of the present invention is to provide an electro-optical device that can achieve desired optical characteristics by eliminating the possibility of transparent electrode conduction failure. An electro-optical device includes a first and a second transparent substrate, an electro-optical material provided between first and second transparent substrates, an optical structure provided on the first or second transparent substrate and having a plurality of segmented lens faces (16a), a conducting structure (2) including a connecting face (23) formed on the optical structure and formed by cutting out a portion of the optical structure or etc., and transparent electrodes formed the plurality of segmented lens faces (16a) and the conducting structure (2), respectively, wherein the transparent electrodes formed on the plurality of segmented lens faces are electrically connected together by the transparent electrode formed on the conducting structure (2).

### FIELD OF THE INVENTION

The present invention relates to an electro-optical device, and more particularly to an electro-optical device that is used for focal length adjustment of an optical apparatus such as a camera, eyewear, and the like.

### BACKGROUND OF THE INVENTION

It is known in the art to provide an optical device using a liquid crystal, and more specifically, a liquid crystal lens whose focal length is controllable by applying voltage. There are various types of liquid crystal lens, including one that uses a glass or other transparent substrate provided with a plano-convex or plano-concave lens structure and achieves variable focal length by utilizing changes in the refractive index of the liquid crystal, and one that uses a transparent substrate provided with a Fresnel lens structure and achieves variable focal length by utilizing changes in the refractive index of the liquid crystal in like manner.

In one example of the liquid crystal lens that uses a transparent substrate provided with a Fresnel lens structure, it is known to provide a configuration in which a transparent electrode is formed on the upper surface of the Fresnel lens structure (for example, patent document 1). If the transparent electrode is formed on the underside of the Fresnel lens structure, and voltage is applied to the liquid crystal layer via the Fresnel lens structure, unevenness may occur in the response characteristics of the liquid crystal, such as aligning and rising of the liquid crystal molecules, because the voltage applied to the liquid crystal layer varies from one place to another due to variations in the thickness, dielectric constant, etc. of the lens portion of the Fresnel lens structure. In view of this, a transparent electrode is formed on the upper surface of the Fresnel lens structure in order to suppress the unevenness in the response characteristics.
Patent document 1: Japanese Unexamined Patent Publication No. S60-50510 (page 2, FIGS. 2 and 3)

### SUMMARY OF THE INVENTION

The transparent electrode is formed by such means as sputtering or evaporation, but the electrode film may not be properly formed on the stepped faces of the Fresnel lens, which can lead to a conduction failure. When this happens, there occur regions where the voltage is not correctly applied to the liquid crystal, and hence the problem that the desired lens characteristics cannot be obtained.

Accordingly, it is an object of the present invention to provide an electro-optical device that can solve the above problem.

It is another object of the present invention to provide an electro-optical device that can achieve desired optical characteristics by eliminating the possibility of transparent electrode conduction failure.

It is still another further object of the present invention to provide an electro-optical device that can achieve desired lens characteristics by eliminating the possibility of transparent electrode conduction failure.

It is a further object of the present invention to provide an electro-optical device that can achieve desired optical characteristics and desired aberration correction characteristics by eliminating the possibility of transparent electrode conduction failure.

An electro-optical device according to the present invention includes a first and a second transparent substrate; an electro-optical material provided between the first and second transparent substrates, an optical structure provided on the first or second transparent substrate and having a plurality of segmented lens faces, a conducting structure formed on the optical structure by sacrificing a portion of the optical structure, and transparent electrodes formed on the plurality of segmented lens faces and the conducting structure, respectively, wherein the transparent electrodes formed on the plurality of segmented lens faces are electrically connected together by the transparent electrode formed on the conducting structure.

Preferably, in the electro-optical device according to the present invention, the optical structure is a Fresnel lens structure, a cylindrical lens array structure, a microlens array structure, or a diffraction grating structure.

Preferably, in the electro-optical device according to the present invention, the conducting structure includes a connecting face connecting between adjacent ones of the plurality of segmented lens faces.

Preferably, in the electro-optical device according to the present invention, the conducting structure includes a connecting face formed by cutting out a portion of the plurality of segmented lens faces.

Preferably, in the electro-optical device according to the present invention, the conducting structure includes a first connecting face formed extending across the plurality of segmented lens faces, and a second connecting face connecting between the first connecting face and the plurality of segmented lens faces.

Preferably, in the electro-optical device according to the present invention, the optical structure is a Fresnel lens structure, and the first and second connecting faces are formed by cutting out a portion of the Fresnel lens structure.

Preferably, in the electro-optical device according to the present invention, the second connecting face is formed in the shape of a ring conforming in shape to the plurality of segmented lens faces.

Preferably, in the electro-optical device according to the present invention, the transparent electrodes include an aberration correcting electrode pattern.

Preferably, in the electro-optical device according to the present invention, the aberration correcting electrode pattern includes a coma correcting electrode pattern, a spherical aberration correcting electrode pattern, or an astigmatism correcting electrode pattern.

Preferably, in the electro-optical device according to the present invention, the electro-optical material is a liquid crystal.

An electro-optical device according to the present invention includes first and second transparent substrates on which electrodes are formed, and a liquid crystal sandwiched between the first and second transparent substrates, wherein a Fresnel lens structure, which has a Fresnel lens face segmented in concentric fashion into a plurality of lens faces that are connected to one another via stepped faces, is formed on at least one of the first and second transparent substrates, and wherein, in a liquid crystal lens with the electrodes formed on the Fresnel lens face, the Fresnel lens structure is provided with a conducting structure for achieving conduction between the electrodes formed on the respectively adjacent segmented lens faces.

Preferably, in the electro-optical device according to the present invention, the thus provided conducting structure includes a connecting face connecting adjacent ones of the segmented lens faces, and an electrode is formed on the connecting face.

According to the present invention, since the transparent electrodes formed on the respective segmented lens faces are electrically connected together by the conducting structure formed on the optical structure, the voltage is correctly applied to the liquid crystal layer via the transparent electrodes provided on the optical structure, and desired optical characteristics can be obtained.

Further, according to the present invention, when the transparent electrodes include an aberration correcting electrode pattern, desired aberration correction characteristics can be obtained in addition to desired optical characteristics.

### BRIEF DESCRIPTION OF THE DRAWINGS

FIG. 1 is a cross-sectional view of a liquid crystal lens.

FIG. 2(a) is a top plan view of a transparent substrate 14 provided with a Fresnel lens structure 18, FIG. 2(b) is a cross-sectional view taken along A-A′ in FIG. 2(a), and FIG. 2(c) is an enlarged view of a portion indicated by reference character L in FIG. 2(b).

FIG. 3 is a perspective view showing the entire Fresnel lens structure.

FIG. 4 is a perspective view of a portion containing a conducting structure 2.

FIG. 5(a) is a top plan view of the transparent substrate 14 provided with the Fresnel lens structure 18, FIG. 5(b) is a cross-sectional view taken along B-B′ in FIG. 5(a), and FIG. 5(c) is an enlarged view of a portion indicated by reference character M in FIG. 5(b).

FIG. 6 is a perspective view of a portion containing a conducting structure 3.

FIG. 7(a) is a top plan view of the transparent substrate 14 provided with the Fresnel lens structure 18, FIG. 7(b) is a cross-sectional view taken along C-C′ in FIG. 7(a), and FIG. 7(c) is an enlarged view of a portion indicated by reference character N in FIG. 7(b).

FIG. 8 is a perspective view showing a portion containing a conducting structure 4.

FIG. 9(a) is a top plan view of the transparent substrate 14 provided with the Fresnel lens structure 18, FIG. 9(b) is a cross-sectional view taken along D-D′ in FIG. 9(a), and FIG. 9(c) is an enlarged view of a portion indicated by reference character O in FIG. 9(b).

FIG. 10 is a perspective view showing a portion containing a conducting structure 5.

FIG. 11(a) is a top plan view of the transparent substrate 14 provided with the Fresnel lens structure 18, FIG. 11(b) is a cross-sectional view taken along E-E′ in FIG. 11(a), and FIG. 11(c) is an enlarged view of a portion indicated by reference character P in FIG. 11(b).

FIG. 12 is a perspective view showing a portion containing a conducting structure 6.

FIG. 13 is a diagram showing an example in which a coma correcting transparent electrode pattern 40 is formed on the Fresnel lens face 16 of the Fresnel lens structure 18 provided within the liquid crystal lens 1.

FIG. 14(a) is a diagram showing the coma correcting transparent electrode pattern 40 formed on the Fresnel lens face 16, FIG. 14(b) is a diagram showing an example of a voltage applied to the transparent electrode pattern 40, and FIG. 14(c) is a diagram showing an example of the coma as corrected by the transparent electrode pattern 40.

FIG. 15 is a diagram showing an example in which a spherical aberration correcting transparent electrode pattern 70 is formed on the Fresnel lens face 16 of the Fresnel lens structure 18 provided within the liquid crystal lens 1.

FIG. 16(a) is a diagram showing the spherical aberration correcting transparent electrode pattern 70, FIG. 16(b) is a diagram showing an example of a voltage applied to the transparent electrode pattern 70, and FIG. 16(c) is a diagram showing an example of the spherical aberration as corrected by the transparent electrode pattern 70.

FIG. 17 is a diagram showing an example in which an astigmatism correcting transparent electrode pattern 100 is formed on the Fresnel lens face 16 of the Fresnel lens structure 18 provided within the liquid crystal lens 1.

FIG. 18(a) is a diagram showing the astigmatism correcting transparent electrode pattern 100, FIG. 18(b) is a diagram showing an example of a voltage applied in the Y-axis direction of the transparent electrode pattern 100, and FIG. 18(c) is a diagram showing an example of the astigmatism in the Y-axis direction as corrected by the transparent electrode pattern 100.

FIG. 19(a) is a diagram showing the transparent electrode pattern 100 of FIG. 18(a) by rotating it through 90 degrees, FIG. 19(b) is a diagram showing an example of a voltage applied in the X-axis direction of the transparent electrode pattern 100, and FIG. 19(c) is a diagram showing an example of the astigmatism in the X-axis direction as corrected by the transparent electrode pattern 100.

FIG. 20 is a diagram showing a first-order Fresnel lens structure 200.

FIG. 21 is a diagram showing a cylindrical lens array structure 210.

FIG. 22 is a diagram showing a microlens array structure 220.

FIG. 23 is a diagram showing a diffraction grating structure 230.

### DETAILED DESCRIPTION OF THE PREFERRED EMBODIMENT

The embodiments of the present invention will be described in detail below with reference to the drawings. It should be noted, however, that the technical scope of the present invention is not limited to the specific embodiments described herein, but extends to the inventions described in the appended claims and their equivalents. It should also be noted that the present invention can also be carried out in other embodiments by making various changes without departing from the spirit and scope of the invention. An electro-optical device according to the present invention will be described below by taking a liquid crystal lens as an example.

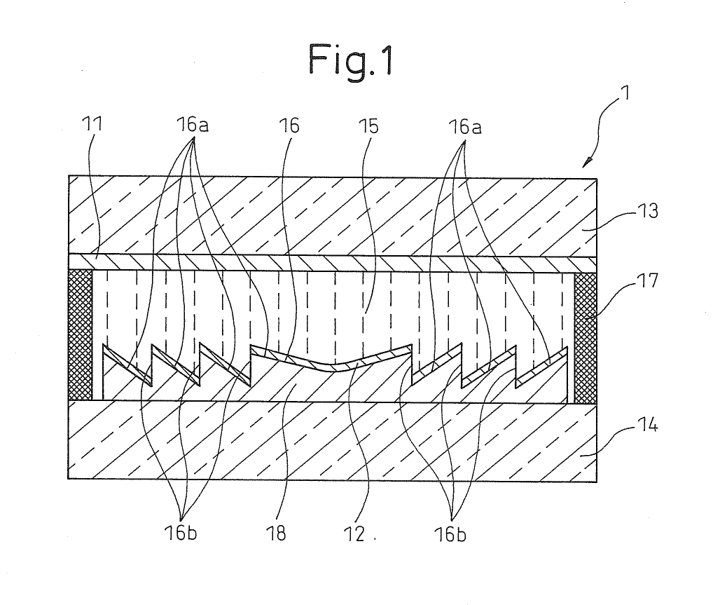

FIG. 1 is a cross-sectional view of a liquid crystal lens 1.

The liquid crystal lens 1 shown in FIG. 1 has a structure in which a liquid crystal layer 15 as an electro-optical material is sandwiched between opposing transparent electrodes 13 and 14. The transparent electrodes 13 and 14 is formed, for example, from glass, polycarbonate, or the like. The liquid crystal used here is, for example, a homogeneously aligned liquid crystal or a vertically aligned liquid crystal. A seal 17 is provided between the edges of the transparent electrodes 13 and 14 to prevent leakage of the liquid crystal and to hold the liquid crystal layer 15 at a prescribed thickness.

A transparent Fresnel lens structure 18 is formed on the transparent substrate 14. The Fresnel lens structure 18 has a Fresnel lens face 16 which is segmented in concentric fashion into a plurality of lens faces 16a that are connected with one another via stepped faces 16b. The Fresnel lens structure 18 is formed from polycarbonate. Alternatively, the Fresnel lens structure 18 may be formed from an optical material such as an acrylate, a transparent resin such as a cyclic olefin-based resin, a radically polymerized acrylic-based US-curable resin, a cationic polymerized epoxy-based US-curable resin, a thermosetting resin, or an inorganic/organic hybrid material. If the stepped faces 16b on the Fresnel lens face 16 are eliminated, the continuous face connecting the segmented lens faces 16a may be formed in a simple spherical shape, but from the standpoint of reducing aberration, it is desirable to form the continuous face in an aspherical shape.

The Fresnel lens structure 18 may be formed on the transparent substrate 13, or may be formed on both of the transparent substrates 13 and 14.

A transparent electrode 11 is formed on the surface of the transparent substrate 13 that faces the Fresnel lens structure 18, and transparent electrodes 12 are formed on the respective faces of the Fresnel lens structure 18 that face the transparent substrate 13.

In the liquid crystal lens 1 of the present invention, the Fresnel lens structure 18 is provided with a conducting structure for achieving conduction between the transparent electrodes 12 formed on the respective segmented lens faces 16a of the Fresnel lens face 16. The details of the conducting structure will be described later.

Alignment films (not shown) for aligning the liquid crystal are formed on the transparent electrodes 11 and 12 provided on the respective transparent substrates 13 and 14. Each alignment film is formed from polyimide, but may be formed from another material. The polyimide film is first calcined and then treated by rubbing so as to provide a prescribed pretilt angle to the liquid crystal.

Next, the operation of the liquid crystal lens 1 will be described.

If the Fresnel lens structure 18 and the liquid crystal layer 15 are made to have the same refractive index as that of glass, for example, the liquid crystal lens 1 functions as a plain glass that has no lens effect, but if the liquid crystal layer 15 is made to have a refractive index different than that of the Fresnel lens face 16, the liquid crystal lens 1 functions as a convex lens or a concave lens, depending on the shape of the Fresnel lens face 16.

When a voltage is applied between the transparent electrodes 11 and 12, the refractive index of the liquid crystal changes, and the power of the lens can thus be changed. The driving voltage applied between the transparent electrodes 11 and 12 is, for example, a pulse-height modulated (PHM) or pulse-width modulated (PWM) AC voltage.

Next, the conducting structure provided on the Fresnel lens structure will be described.

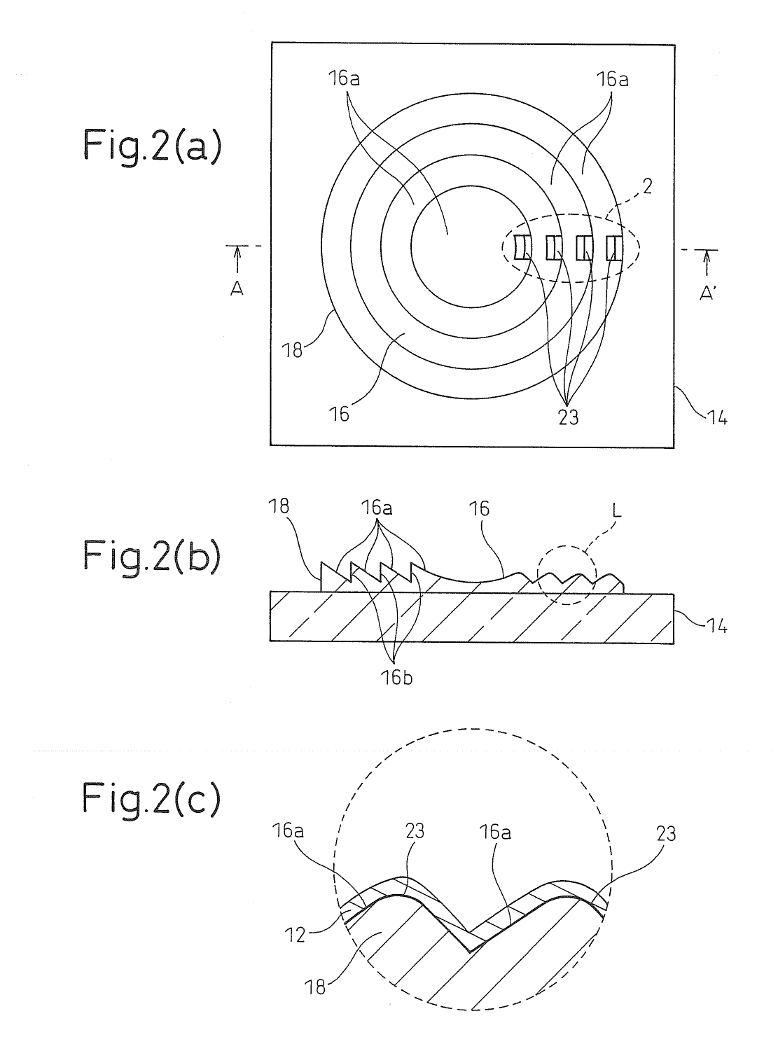

FIGS. 2 to 4 are diagrams showing the conducting structure 2 provided within the liquid crystal lens 1.

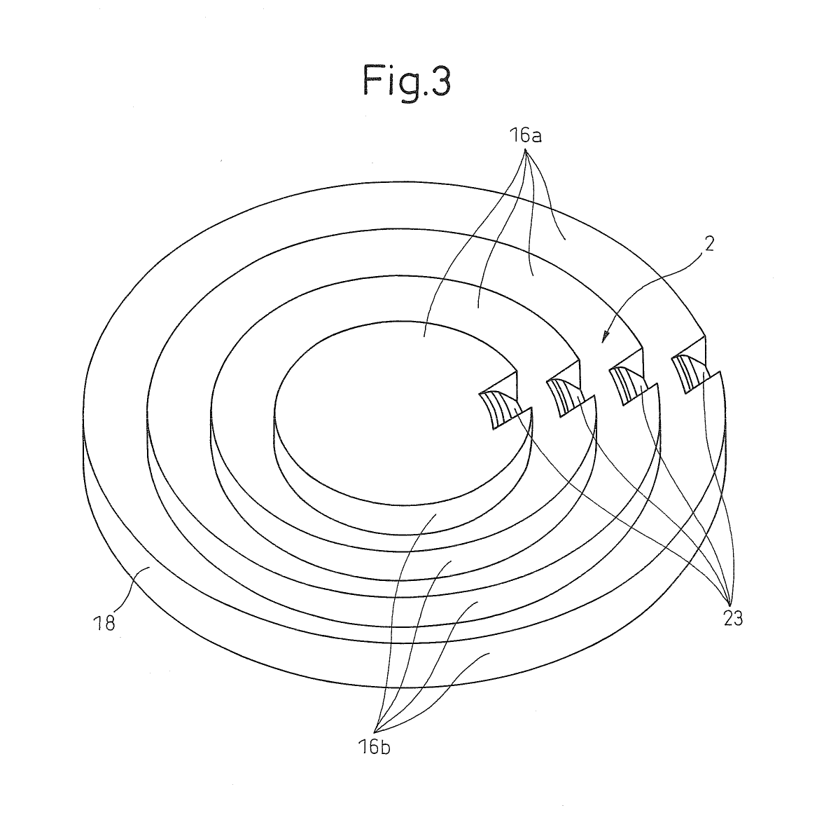

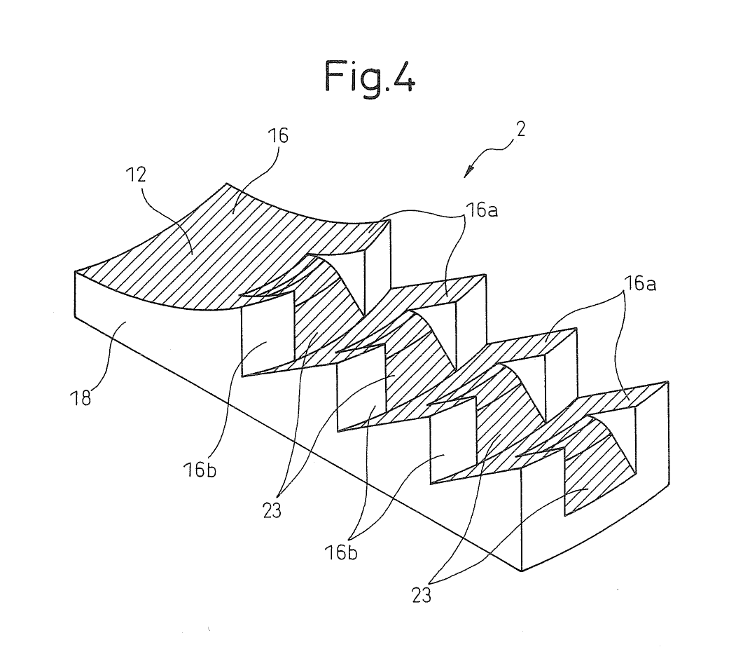

FIG. 2(a) is a top plan view of the transparent substrate 14 provided with the Fresnel lens structure 18, FIG. 2(b) is a cross-sectional view taken along A-A′ in FIG. 2(a), and FIG. 2(c) is an enlarged view of a portion indicated by reference character L in FIG. 2(b). FIG. 3 is a perspective view showing the entire Fresnel lens structure 18 provided with the conducting structure 2. Further, FIG. 4 is a perspective view of a portion containing the conducting structure 2.

As shown in FIGS. 2 to 4, the conducting structure 2 includes connecting faces 23 each connecting between adjacent segmented lens faces 16a by a gently sloping face formed by cutting out a portion of the Fresnel lens structure 18. The transparent electrode 12 is formed on each connecting face 23 as well as on each segmented lens face 16a.

With the conducting structure 2 thus provided, the transparent electrodes 12 formed on the respective segmented lens faces 16a are electrically connected together by the transparent electrode 12 formed on the connecting face 23. As a result, the voltage is correctly applied to the liquid crystal layer via the transparent electrodes 12 provided on the Fresnel lens face 16, and the desired lens characteristics can be obtained.

The Fresnel lens structure 18 provided with the conducting structure 2 described above is formed by mold transfer. The mold for transferring the Fresnel lens structure 18 provided with the conducting structure 2 must be fabricated so as to have not only a pattern shape for forming the Fresnel lens face 16 but also a raised pattern shape for forming the connecting faces 23. However, it is technically difficult to generate the raised pattern shape by cutting, etc.

In view of this, an electroforming process is used to generate the mold. First, a master mold is fabricated that has patterns that match the shapes of the Fresnel lens face 16 and the connecting faces 23. Since the connecting faces 23 are each formed in a recessed shape by cutting out a portion of the Fresnel lens structure 18, the master mold can be easily generated by cutting, etc. Next, an electroformed structure is generated from the master mold, and the thus generated structure is used as a mold for transferring the Fresnel lens structure 18 provided with the conducting structure 2. Using such a process, the mold for transferring the Fresnel lens structure 18 provided with the conducting structure 2 can be easily generated.

The method for forming the Fresnel lens structure 18 provided with the conducting structure 2 is not limited to the above method. For example, the Fresnel lens structure 18 provided with the conducting structure 2 can also be formed by first forming only the pattern of the Fresnel lens face 16 by mold transfer and then applying processing such as machining to the pattern portion of the Fresnel lens face 16 to generate the conducting structure having the connecting faces 23.

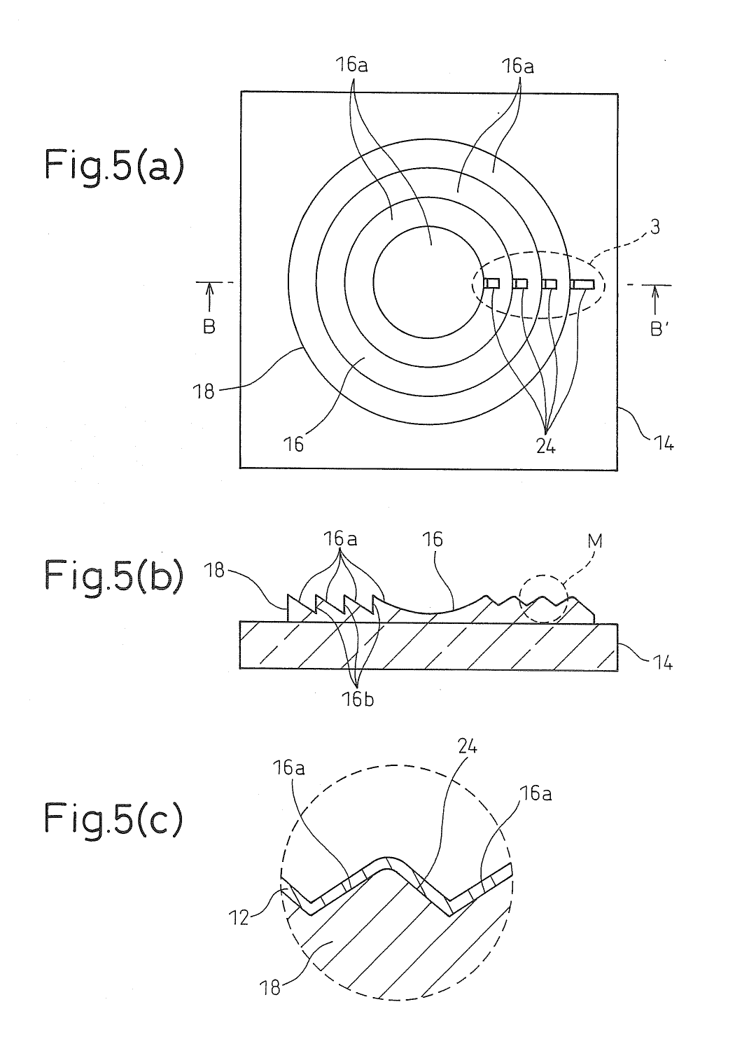

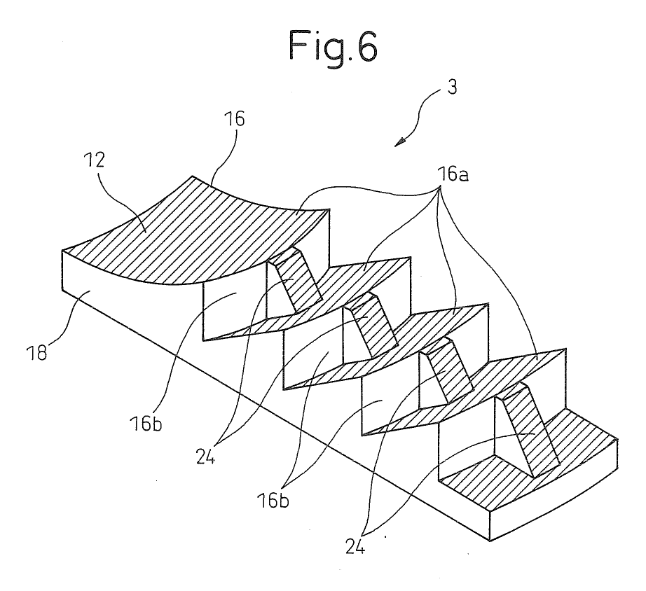

FIGS. 5 and 6 are diagram showing an alternative conducting structure 3. The conducting structure 3 can be provided on the Fresnel lens structure 18 in place of the above-described conducting structure 2.

FIG. 5(a) is a top plan view of the transparent substrate 14 provided with the Fresnel lens structure 18, FIG. 5(b) is a cross-sectional view taken along B-B° in FIG. 5(a), and FIG. 5(c) is an enlarged view of a portion indicated by reference character M in FIG. 5(b). FIG. 6 is a perspective view showing a portion of the Fresnel lens structure 18 provided with the conducting structure 3.

As shown in FIGS. 5 and 6, the conducting structure 3 includes connecting faces 24 each connecting between adjacent segmented lens faces 16a by a gently sloping face extending from an edge of one segmented lens face 16a to its adjacent segmented lens face 16a. The connecting faces 24 are each formed in a raised shape on the Fresnel lens structure 18. The transparent electrode 12 is formed on each connecting face 24 as well as on each segmented lens face 16a.

With the conducting structure 3 thus provided, the transparent electrodes 12 formed on the respective segmented lens faces 16a are electrically connected together by the transparent electrode 12 formed on the connecting face 24, as in the case of the earlier described conducting structure 2. As a result, the voltage is correctly applied to the liquid crystal layer via the transparent electrodes 12 provided on the Fresnel lens face 16, and the desired lens characteristics can be obtained.

The mold for transferring the Fresnel lens structure 18 provided with the conducting structure 3 can be fabricated by first forming a pattern for forming the Fresnel lens face 16 and then cutting the pattern so as to generate the shape of the connecting faces 24. Accordingly, the mold for transferring the Fresnel lens structure 18 provided with the conducting structure 3 can be easily fabricated, compared with the conducting structure 2 that requires the generation of an electroformed structure.

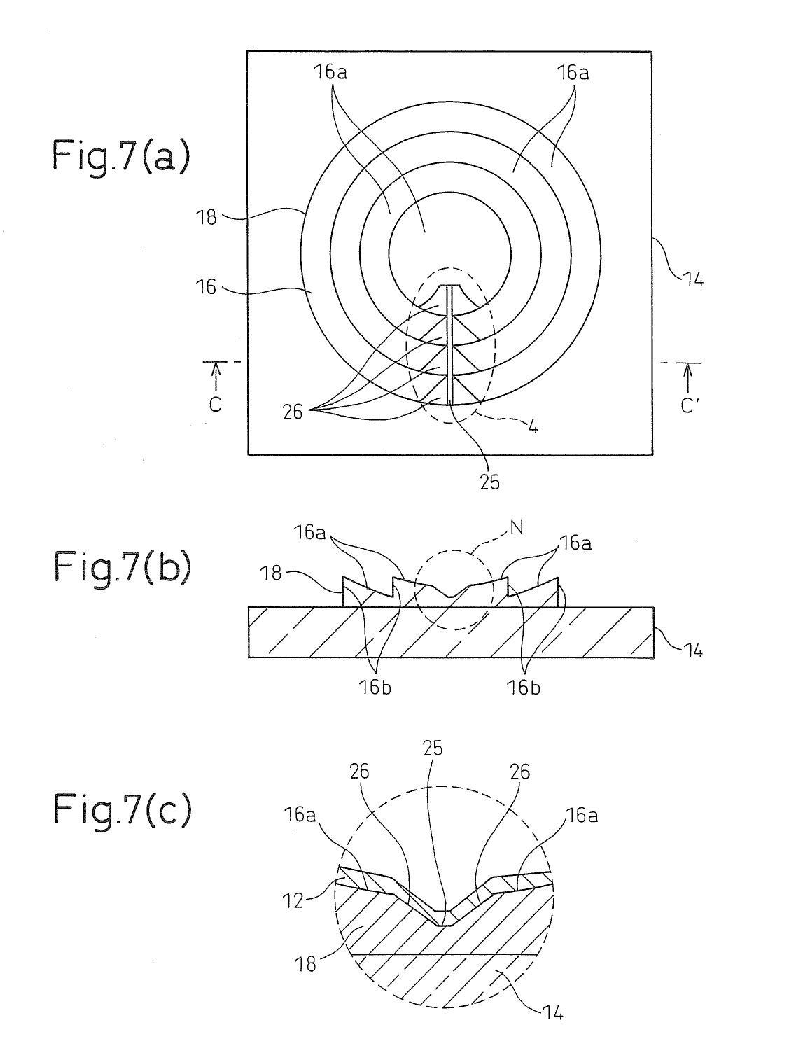

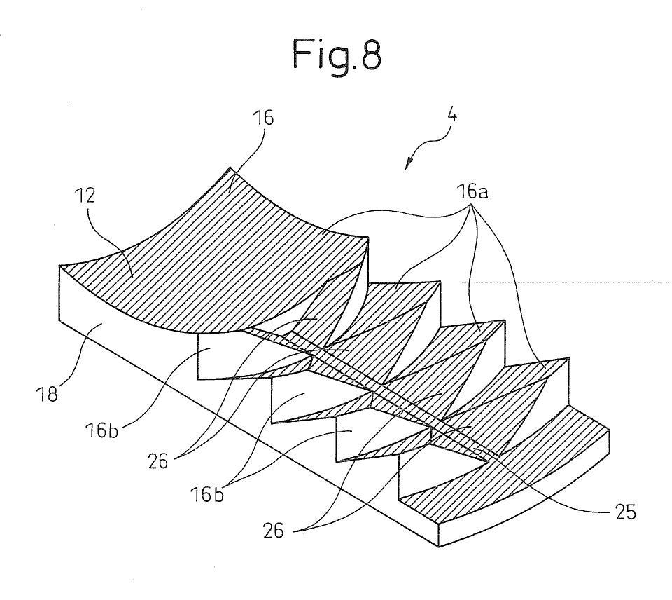

FIGS. 7 and 8 are diagram showing another alternative conducting structure 4. The conducting structure 4 can be provided on the Fresnel lens structure 18 in place of the earlier described conducting structure 2.

FIG. 7(a) is a top plan view of the transparent substrate 14 provided with the Fresnel lens structure 18, FIG. 7(b) is a cross-sectional view taken along C-C′ in FIG. 7(a), and FIG. 7(c) is an enlarged view of a portion indicated by reference character N in FIG. 7(b). FIG. 8 is a perspective view showing a portion of the Fresnel lens structure 18 provided with the conducting structure 4.

As shown in FIGS. 7 and 8, the conducting structure 4 includes a first connecting face 25 formed extending across the plurality of segmented lens faces 16a by cutting out a portion of the Fresnel lens structure 18 and a second connecting face 26 connecting between the connecting face 25 and each segmented lens face 16a by a gently sloping face formed by likewise cutting out a portion of the Fresnel lens structure 18. The transparent electrode 12 is formed on each of the first and second connecting faces 25 and 26 as well as on each segmented lens face 16a. As shown in FIG. 8, the first connecting face 25 is formed in the shape of a strip having a predetermined constant width. The second connecting face 26 is formed in a substantially rectangular shape whose bottom side is connected to the first connecting face 25 as shown in FIG. 8.

With the conducting structure 4 thus provided, the transparent electrodes 12 formed on the respective segmented lens faces 16a are electrically connected together by the transparent electrodes 12 formed on the first and second connecting faces 25 and 26. As a result, the voltage is correctly applied to the liquid crystal layer via the transparent electrodes 12 provided on the Fresnel lens face 16, and the desired lens characteristics can be obtained.

The mold for transferring the Fresnel lens structure 18 provided with the conducting structure 4 must be fabricated so as to have not only a pattern shape for forming the Fresnel lens face 16 but also a raised pattern shape for forming the first and second connecting faces 25 and 26. However, it is technically difficult to generate the raised pattern shape by cutting, etc.

In view of this, the mold for forming the conducting structure 4 is produced using an electroforming process, as in the case of the conducting structure 2. First, a master mold is fabricated that has patterns that match the shapes of the Fresnel lens face 16 and the first and second connecting faces 25 and 26. Since the first and second connecting faces 25 and 26 are each formed in a recessed shape by cutting out a portion of the Fresnel lens structure 18, the master mold can be easily generated by cutting, etc. Next, an electroformed structure is generated from the master mold, to produce the mold for transferring the Fresnel lens structure 18 provided with the conducting structure 4.

The method for forming the Fresnel lens structure 18 provided with the conducting structure 4 is not limited to the above method. For example, the Fresnel lens structure 18 provided with the conducting structure 4 can also be formed by first forming only the pattern of the Fresnel lens face 16 by mold transfer and then applying processing such as machining to the pattern portion of the Fresnel lens face 16 to generate the conducting structure having the first and second connecting faces 25 and 26.

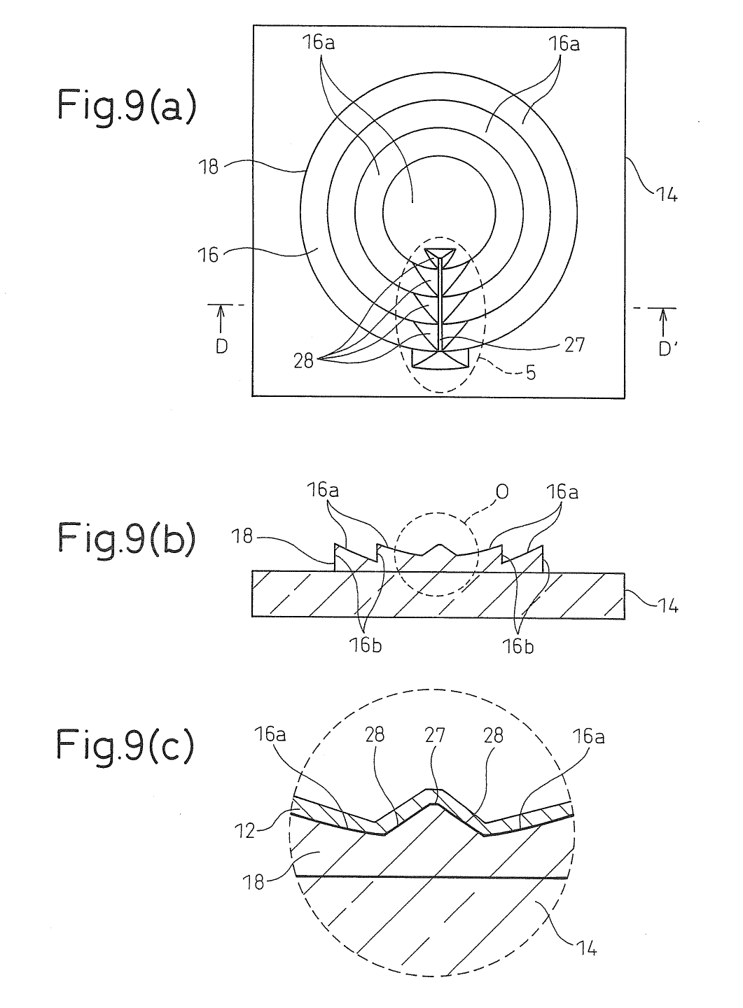

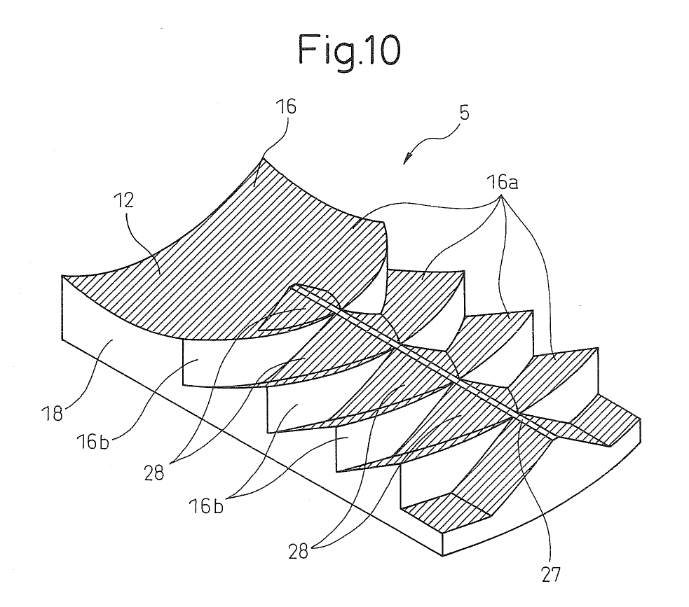

FIGS. 9 and 10 are diagram showing still another alternative conducting structure 5. The conducting structure 5 can be provided on the Fresnel lens structure 18 in place of the earlier described conducting structure 2.

FIG. 9(a) is a top plan view of the transparent substrate 14 provided with the Fresnel lens structure 18, FIG. 9(b) is a cross-sectional view taken along D-D′ in FIG. 9(a), and FIG. 9(c) is an enlarged view of a portion indicated by reference character O in FIG. 9(b). FIG. 10 is a perspective view showing a portion of the Fresnel lens structure 18 provided with the conducting structure 5.

The conducting structure 5 includes a first connecting face 27 formed extending across the plurality of segmented lens faces 16a and a second connecting face 28 connecting between the first connecting face 27 and each segmented lens face 16a by a gently sloping face. The first and second connecting faces 27 and 28 are formed in a raised shape on the Fresnel lens structure 18. The transparent electrode 12 is formed on each of the first and second connecting faces 27 and 28 as well as on each segmented lens face 16a. As shown in FIG. 10, the first connecting face 27 is formed in the shape of a strip having a predetermined constant width. The second connecting face 28 is formed in a substantially rectangular shape whose bottom side is connected to the first connecting face 27 as shown in FIG. 10.

With the conducting structure 5 thus provided, the transparent electrodes 12 formed on the respective segmented lens faces 16a are electrically connected together by the transparent electrodes 12 formed on the first and second connecting faces 27 and 28. As a result, the voltage is correctly applied to the liquid crystal layer via the transparent electrodes 12 provided on the Fresnel lens face 16, and the desired lens characteristics can be obtained.

The mold for transferring the Fresnel lens structure 18 provided with the conducting structure 5 can be fabricated by first forming a pattern for forming the Fresnel lens face 16 and then cutting the pattern so as to generate the shape of the first and second connecting faces 27 and 28.

Accordingly, the mold for transferring the Fresnel lens structure 18 provided with the conducting structure 5 can be easily fabricated, compared with the conducting structure 4 that requires the generation of an electroformed structure.

In the conducting structures 4 and 5 shown in FIGS. 8 and 10, the effects that the provision of the conducting structure will have on the optical characteristics can be suppressed by reducing the width of the first connecting face 25 or 27 in a direction orthogonal to the radial direction of the Fresnel lens face 16.

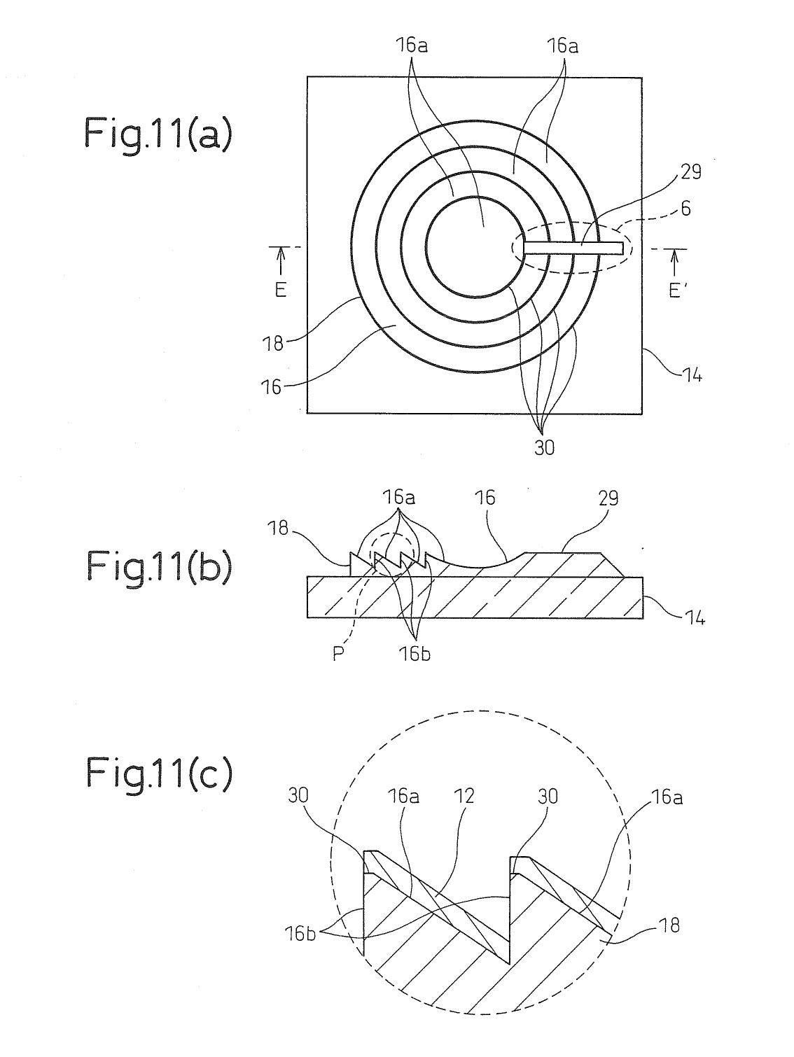

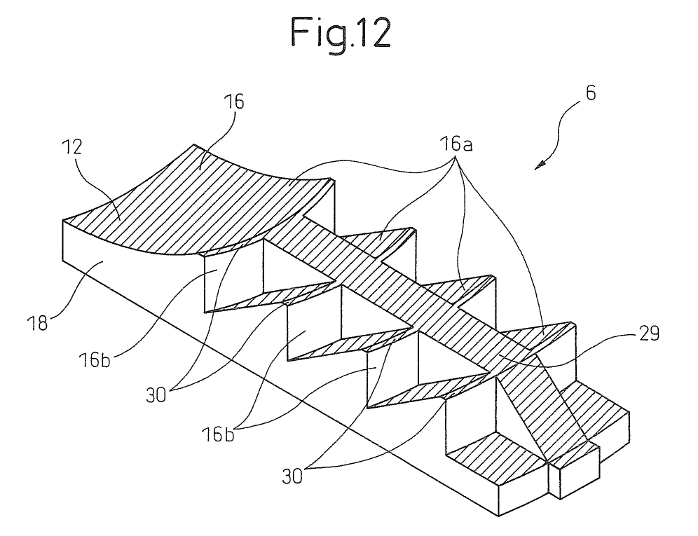

FIGS. 11 and 12 are diagram showing yet another alternative conducting structure 6. The conducting structure 6 can be provided on the Fresnel lens structure 18 in place of the earlier described conducting structure 2.

FIG. 11(a) is a top plan view of the transparent substrate 14 provided with the Fresnel lens structure 18, FIG. 11(b) is a cross-sectional view taken along E-E′ in FIG. 11(a), and FIG. 11(c) is an enlarged view of a portion indicated by reference character P in FIG. 11(b). FIG. 12 is a perspective view showing a portion of the Fresnel lens structure 18 provided with the conducting structure 6.

As shown in FIGS. 11 and 12, the conducting structure 6 includes a first connecting face 29 formed in a strip-like shape extending across the plurality of segmented lens faces 16a and a second connecting face 30 formed in a ring shape along an edge of each segmented lens face 16a in such a manner as to connect with the first connecting face 29. The transparent electrode 12 is formed on each of the first and second connecting faces 29 and 30 as well as on each segmented lens face 16a.

With the conducting structure 6 thus provided, the transparent electrodes 12 formed on the respective segmented lens faces 16a are electrically connected together by the transparent electrodes 12 formed on the first and second connecting faces 29 and 30. As a result, the voltage is correctly applied to the liquid crystal layer via the transparent electrodes 12 provided on the Fresnel lens face 16, and the desired lens characteristics can be obtained.

FIGS. 11 and 12 are examples in which the ring-shaped second connecting face 30 is formed along the outer edge of each segmented lens face 16a which is farthest from the transparent substrate 14. However, the present invention is not limited to this particular example, but the ring-shaped second connecting face 30 may be formed along some other portion of each segmented lens face 16a. By forming the ring-shaped second connecting face 30 along the edge of each segmented lens face 16a, the effects that the provision of the conducting structure will have on the optical characteristics can be suppressed.

Further, in the example shown in FIGS. 11 and 12, the ring-shaped second connecting face 30 has been shown as being formed along the entire peripheral edge of each segmented lens face 16a, but it may be formed along a portion of the peripheral edge of each segmented lens face 16a.

In the case of the conducting structures 2 and 3, the conducting structure is formed without sacrificing the entire region extending radially across each segmented lens face 16a. Accordingly, compared with the conducting structures 4 to 6 in which the conducting structure is formed by sacrificing a portion of the region extending radially across each segmented lens face 16a, the conducting structures 2 and 3 can further suppress the effects that they will have on the optical characteristics.

In the case of the conducting structures 4 to 6, the conducting structure is formed extending across the plurality of segmented lens faces 16a. Accordingly, compared with the conducting structures 2 and 3 in which the conducting structure is formed using only a portion of each segmented lens face 16a in the radial direction thereof, each of the conducting structures 4 to 6 can be easily formed on the Fresnel lens structure 18 even when the segmented lenses 16a are arranged at a smaller pitch.

In the above example, the conducting structures 1 to 6 have each been shown as having connecting faces arranged radially in a single row on the Fresnel lens face 16. However, the present invention is not limited to this particular example, but the connecting faces may be formed at positions located in different directions when viewed from the center of the Fresnel lens face 16.

While the above example has dealt with the configuration in which the transparent electrodes 12 are formed over the entire area of the Fresnel lens face 16, the following describes an example in which a transparent electrode pattern for aberration correction is formed on the Fresnel lens face 16.

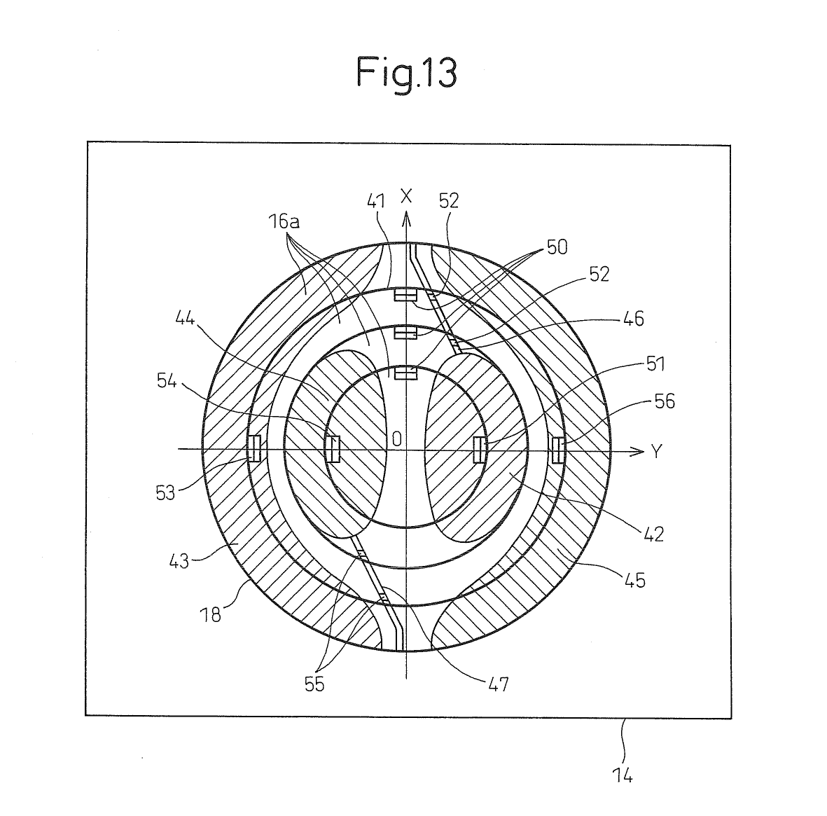

FIG. 13 is a diagram showing an example in which a coma correcting transparent electrode pattern 40 is formed on the Fresnel lens face 16 of the Fresnel lens structure 18 provided within the liquid crystal lens 1.

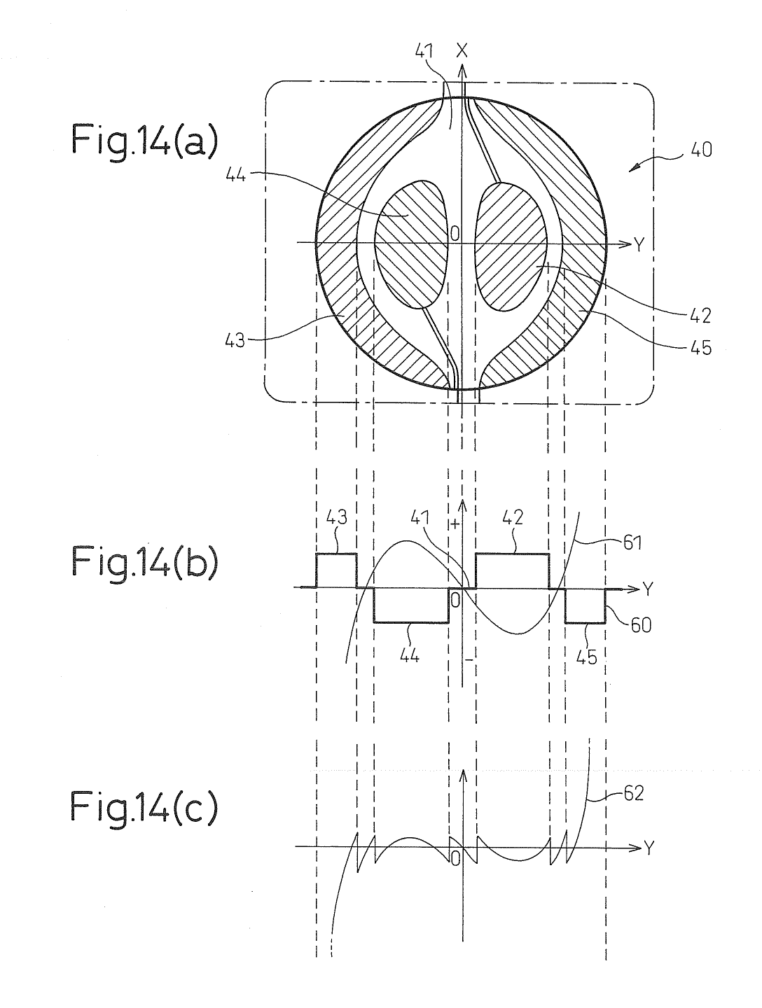

In an optical pickup device which reads or writes data on a recording medium such as a CD, DVD, or Blu-ray disc, a light beam from a light source is converted by a collimator lens into a substantially parallel beam of light which is focused by an objective lens onto the recording medium, and an information signal is generated by receiving the light beam reflected from the recording medium. In such an optical pickup device, when reading or writing data on the recording medium, the light beam focused by the objective lens must be made to accurately follow the desired track on the recording medium. However, a tilt can occur at the surface of the recording medium, due to warping or curving of the recording medium, imperfections in the recording medium driving mechanism, etc. If the optical axis of the light beam focused by the objective lens is tilted relative to the track on the recording medium, an aberration called coma occurs in the substrate of the recording medium; that is, when seen at the position of the entrance pupil of the objective lens, coma 61 such as shown in FIG. 14(b) occurs, which can lead to a degradation of the information signal generated based on the light beam reflected from the recording medium.

In view of this, the coma correcting electrode pattern 40 shown in FIG. 13 is formed on the Fresnel lens face 16 so that the liquid crystal lens 1 can correct for coma while at the same time adjusting the focal length.

As shown in FIG. 13, the coma correcting electrode pattern 40 is formed from electrodes 41 to 45. However, since the Fresnel lens face 16 has stepped faces 16b such as shown in FIG. 3, electrical conduction across each electrode may not be fully accomplished.

In view of this, for the electrode 41 which is formed across all the four segmented lens faces 16a, first connecting faces 50 are provided at three different places so that the entire electrode 41 may be maintained at the same potential. For the electrode 42 which is formed across two segmented lens faces 16a, a second connecting face 51 is provided at one place so that the entire electrode 42 may be maintained at the same potential. Further, since a lead wire 46 from the electrode 42 is routed over three segmented lens faces 16a, third connecting faces 52 are provided at two different places. For the electrode 43 which is formed across two segmented lens faces 16a, a fourth connecting face 53 is provided at one place so that the entire electrode 43 may be maintained at the same potential. For the electrode 44 which is formed across two segmented lens faces 16a, a fifth connecting face 54 is provided at one place so that the entire electrode 44 may be maintained at the same potential. Further, since a lead wire 47 from the electrode 44 is routed over three segmented lens faces 16a, sixth connecting faces 55 are provided at two different places. For the electrode 45 which is formed across two segmented lens faces 16a, a seventh connecting face 56 is provided at one place so that the entire electrode 45 may be maintained at the same potential.

The first to seventh connecting faces 50 to 56 shown in FIG. 13 are identical in shape to the connecting faces 23 of the conducting structure 2 shown in FIG. 4. However, the shapes of the connecting faces of the alternative conducting structures 3 to 6 may be utilized. Further, the coma correcting electrode pattern 40 shown in FIG. 13 is only one example, and any other suitable pattern may be utilized.

FIG. 14 is a diagram explaining how the coma correction is done by the coma correcting electrode pattern 40. FIG. 14(a) shows the coma correcting transparent electrode pattern 40 formed on the Fresnel lens face 16, FIG. 14(b) shows an example of a voltage applied to the transparent electrode pattern 40, and FIG. 14(c) shows an example of the coma as corrected by the transparent electrode pattern 40. In FIG. 14(a), the connecting faces 50 to 55 shown in FIG. 13 are omitted from illustration.

Voltage 60 such as shown in FIG. 14(b) is applied to the respective regions of the coma correcting transparent electrode pattern 40. When the voltage 60 such as shown in FIG. 14(b) is applied to the transparent electrode pattern 40 such as shown in FIG. 14(a), a potential difference occurs with respect to the transparent counter electrode 11 (see FIG. 1), and the alignment of the liquid crystal between them changes according to the potential difference. As a result, the light beam passing through this portion experiences an effect that advances its phase according to the potential difference. With this effect, the coma 61 occurring in the substrate of the recording medium is corrected as shown by the coma 62 in FIG. 14(c).

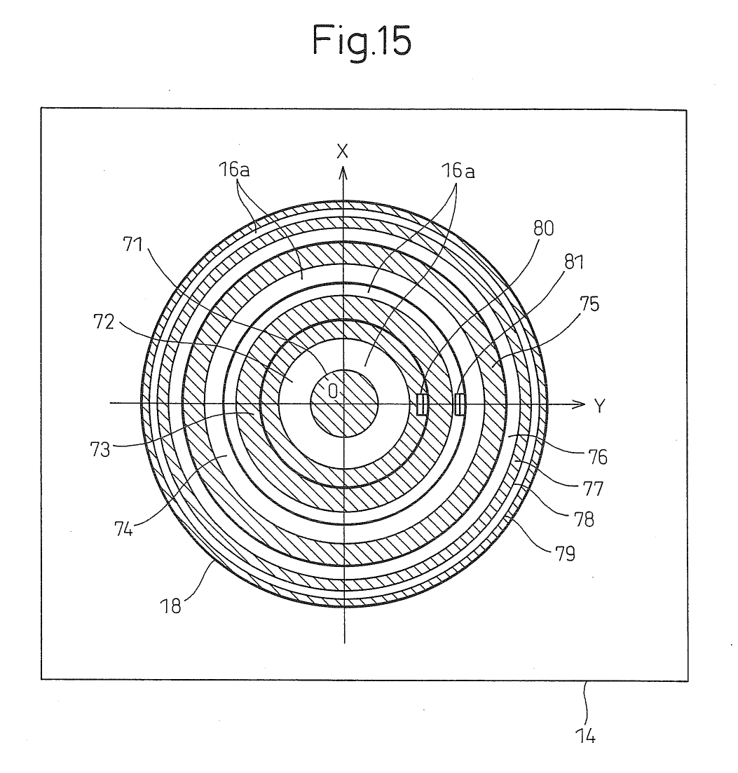

FIG. 15 is a diagram showing an example in which a spherical aberration correcting transparent electrode pattern 70 is formed on the Fresnel lens face 16 of the Fresnel lens structure 18 provided within the liquid crystal lens 1.

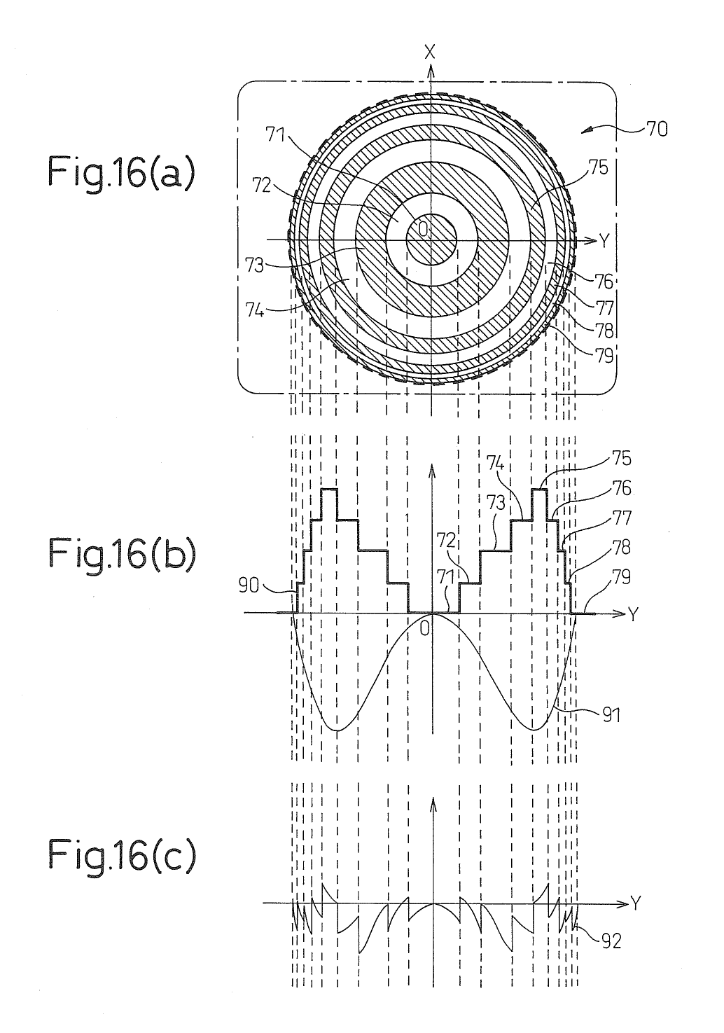

There are case where, due to imperfections such as irregularities in the thickness of the optically transmissive protective layer formed on the track surface of the recording medium, the distance between the objective lens and the track surface varies or the light spot cannot be always focused in the same condition. Such variations in the distance between the objective lens and the track surface cause spherical aberration in the substrate of the recording medium, which can lead to a degradation of the light intensity signal generated based on the reflected beam from the recording medium. One example of the spherical aberration as seen at the position of the entrance pupil of the objective lens is shown at 91 in FIG. 16(b).

In view of this, the spherical aberration correcting electrode pattern 70 shown in FIG. 15 is formed on the Fresnel lens face 16 so that the liquid crystal lens 1 can correct for spherical aberration while at the same time adjusting the focal length.

As shown in FIG. 15, the spherical aberration correcting electrode pattern 70 is formed from electrodes 71 to 79. However, since the Fresnel lens face 16 has stepped faces 16b such as shown in FIG. 3, electrical conduction across each electrode may not be fully accomplished.

In view of this, for the electrode 73 which is formed over the entire region of two segmented lens faces 16a, a first connecting face 80 is provided at one place so that the entire electrode 73 may be maintained at the same potential. For the electrode 74 which is formed across two segmented lens faces 16a, a second connecting face 81 is provided at one place so that the entire electrode 74 may be maintained at the same potential.

For the electrodes 71, 72, and 75 to 79, no connecting faces are provided since each of these electrodes is formed within the same segmented lens face 16a. Here, the lead wires from the respective electrodes are not shown for convenience of illustration. However, if there is any lead wire that is routed over a plurality of segmented lens faces 16a, a connecting face or faces must be provided for such a lead wire as previously illustrated in FIG. 13.

The first and second connecting faces 80 and 81 shown in FIG. 15 are identical in shape to the connecting faces 23 of the conducting structure 2 shown in FIG. 4. However, the shapes of the connecting faces of the alternative conducting structures 3 to 6 may be utilized. Further, the spherical aberration correcting electrode pattern 70 shown in FIG. 15 is only one example, and any other suitable pattern may be utilized.

FIG. 16 is a diagram for explaining how the spherical aberration correction is done by the spherical aberration correcting electrode pattern 70. FIG. 16(a) shows the spherical aberration correcting transparent electrode pattern 70, FIG. 16(b) shows an example of a voltage applied to the transparent electrode pattern 70, and FIG. 16(c) shows an example of the spherical aberration as corrected by the transparent electrode pattern 70. In FIG. 16(a), the connecting faces 80 and 81 shown in FIG. 15 are omitted from illustration.

Voltage 90 such as shown in FIG. 16(b) is applied to the respective regions of the spherical aberration correcting transparent electrode pattern 70. When the voltage 90 such as shown in FIG. 16(b) is applied to the transparent electrode pattern 70 such as shown in FIG. 16(a), a potential difference occurs with respect to the transparent counter electrode 11 (see FIG. 1), and the alignment of the liquid crystal between them changes according to the potential difference. As a result, the light beam passing through this portion experiences an effect that advances its phase according to the potential difference. With this effect, the spherical aberration 91 occurring in the substrate of the recording medium is corrected as shown by the spherical aberration 92 in FIG. 16(c).

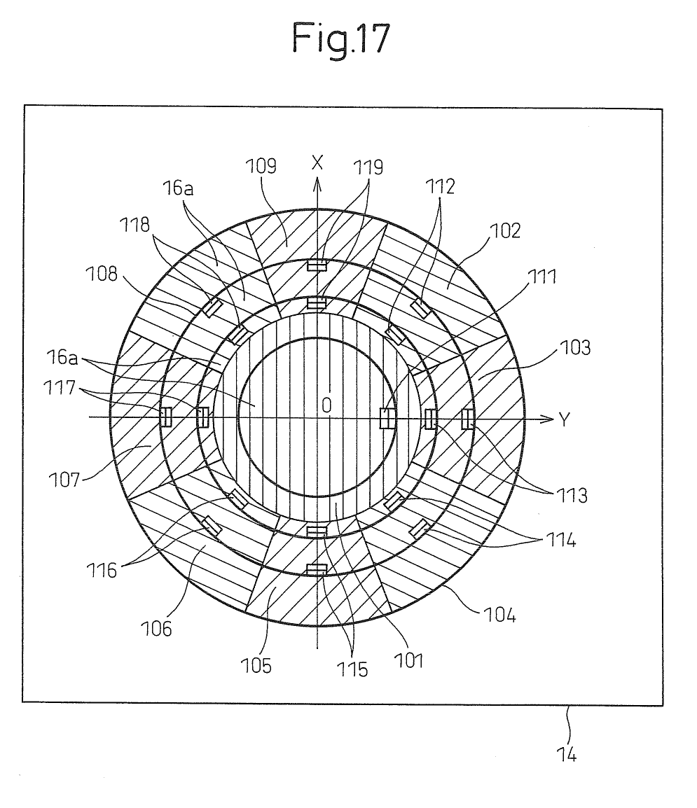

FIG. 17 is a diagram showing an example in which an astigmatism correcting transparent electrode pattern 100 is formed on the Fresnel lens face 16 of the Fresnel lens structure 18 provided within the liquid crystal lens 1.

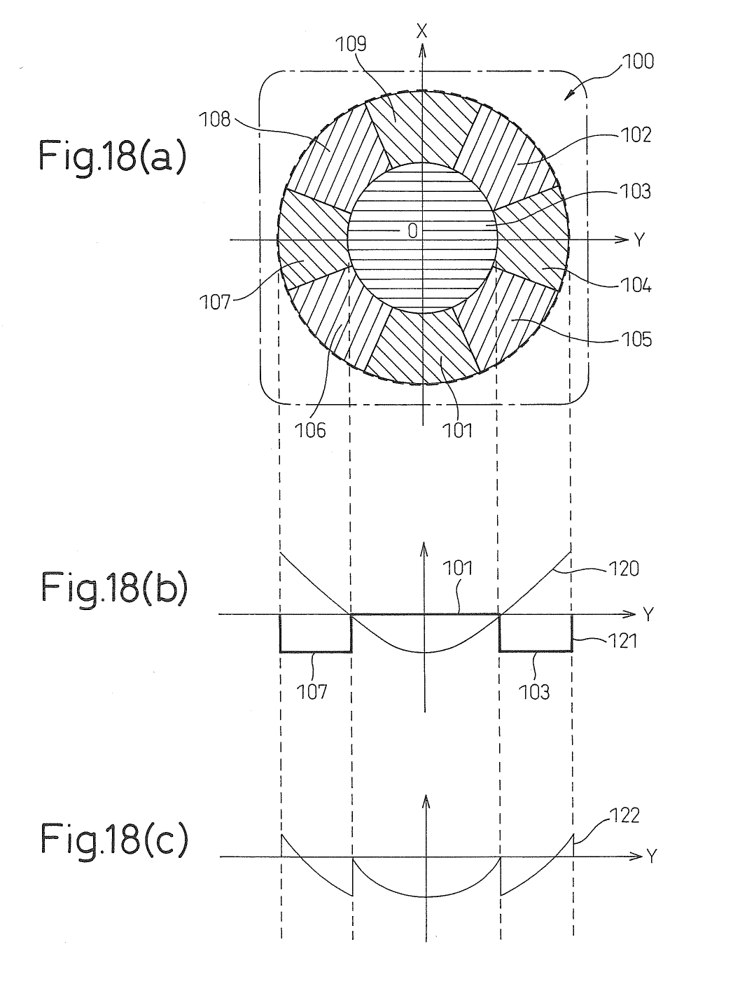

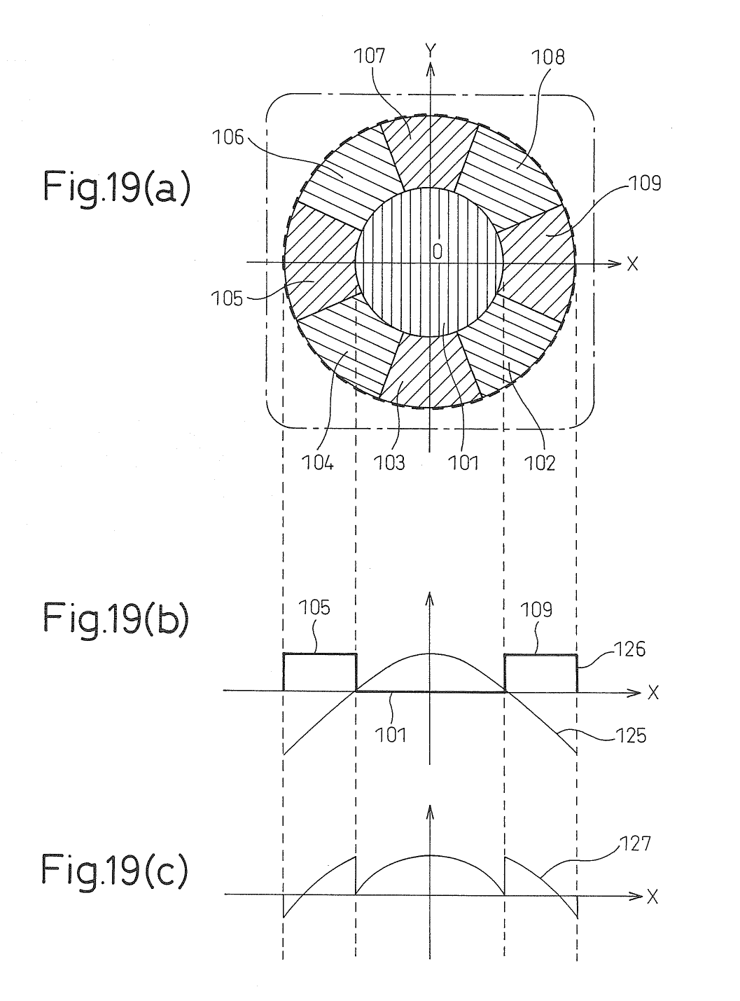

In an optical pickup device which reads or writes data on a recording medium, due to the problem of the astigmatic difference of a semiconductor laser, etc. astigmatism 120 such as shown in FIG. 18(b) occurs in the Y-axis direction in the light beam emitted from the light source, and astigmatism 125 such as shown in FIG. 19(b) occurs in the X-axis direction, which can lead to a degradation of the information signal generated based on the reflected beam from the recording medium. The astigmatism as a whole can be modeled to have the form Z=X²·Y² (X and Y are pupil coordinates, and Z is the amount of phase).

In view of this, the astigmatism correcting electrode pattern 100 shown in FIG. 17 is formed on the Fresnel lens face 16 so that the liquid crystal lens 1 can correct for astigmatism while at the same time adjusting the focal length.

As shown in FIG. 17, the astigmatism correcting electrode pattern 100 is formed from electrodes 101 to 109. However, since the Fresnel lens face 16 has stepped faces 16b such as shown in FIG. 3, electrical conduction across each electrode may not be fully accomplished.

In view of this, for the electrode 101 which is formed over the entire region of two segmented lens faces 16a, a first connecting face 111 is provided at one place so that the entire electrode 101 may be maintained at the same potential. For the electrode 102 which is formed across three segmented lens faces 16a, second connecting faces 112 are provided at two different places so that the entire electrode 102 may be maintained at the same potential. For the electrode 103 which is formed across three segmented lens faces 16a, third connecting faces 113 are provided at two different places so that the entire electrode 103 may be maintained at the same potential. For the electrode 104 which is formed across three segmented lens faces 16a, fourth connecting faces 114 are provided at two different places so that the entire electrode 104 may be maintained at the same potential. For the electrode 105 which is formed across three segmented lens faces 16a, fifth connecting faces 115 are provided at two different places so that the entire electrode 105 may be maintained at the same potential. For the electrode 106 which is formed across three segmented lens faces 16a, sixth connecting faces 116 are provided at two different places so that the entire electrode 106 may be maintained at the same potential. For the electrode 107 which is formed across three segmented lens faces 16a, seventh connecting faces 117 are provided at two different places so that the entire electrode 107 may be maintained at the same potential. For the electrode 108 which is formed across three segmented lens faces 16a, eighth connecting faces 118 are provided at two different places so that the entire electrode 108 may be maintained at the same potential. For the electrode 109 which is formed across three segmented lens faces 16a, ninth connecting faces 119 are provided at two different places so that the entire electrode 109 may be maintained at the same potential.

The lead wires from the respective electrodes are not shown for convenience of illustration. However, if there is any lead wire that is routed over a plurality of segmented lens faces 16a, a connecting face or faces must be provided for such a lead wire as previously illustrated in FIG. 13.

The first to ninth connecting faces 111 to 119 shown in FIG. 17 are identical in shape to the connecting faces 23 of the conducting structure 2 shown in FIG. 4. However, the shapes of the connecting faces of the alternative conducting structures 3 to 6 may be utilized. Further, the astigmatism correcting electrode pattern 100 shown in FIG. 17 is only one example, and any other suitable pattern may be utilized.

FIG. 18(a) shows the astigmatism correcting transparent electrode pattern 100, FIG. 18(b) shows an example of the voltage applied in the Y-axis direction of the transparent electrode pattern 100, and FIG. 18(c) shows an example of the astigmatism in the Y-axis direction as corrected by the transparent electrode pattern 100. FIG. 19(a) shows the transparent electrode pattern 100 of FIG. 18(a) by rotating it through 90 degrees, FIG. 19(b) shows an example of the voltage applied in the X-axis direction of the transparent electrode pattern 100, and FIG. 19(c) shows an example of the astigmatism in the X-axis direction as corrected by the transparent electrode pattern 100. In FIGS. 18(a) and 19(a), the connecting faces 111 to 119 shown in FIG. 17 are omitted from illustration.

Voltage 121 such as shown in FIG. 18(b) and voltage 126 such as shown in FIG. 19(b) are applied to the respective regions of the transparent electrode pattern 110 shown in FIGS. 18(a) and 19(a). When the voltage 120 such as shown in FIG. 18(b) and the voltage 126 such as shown in FIG. 19(b) are applied to the transparent electrode pattern 100 such as shown in FIGS. 18(a) and 19(a), a potential difference occurs with respect to the transparent counter electrode 11 (see FIG. 1), and the alignment of the liquid crystal between them changes according to the potential difference. As a result, the light beam passing through this portion experiences an effect that advances its phase according to the potential difference. With this effect, the astigmatism 120 in the Y-axis direction and the astigmatism 125 in the X-axis direction, occurring in the substrate of the recording medium, are corrected as shown by the astigmatism 122 in FIG. 18(c) and the astigmatism 127 in FIG. 19(c), respectively.

In the above example, the Fresnel lens structure 18 has four segmented lens faces 16a, but the number of segmented lens faces 16a is not limited to four, and it can be changed variously, for example, to 10, 100, etc., according to the purpose.

While the above example has been described for the case of the liquid crystal lens 1 that employs the Fresnel lens structure 18, the following describes examples in which other optical structures are employed for the liquid crystal lens 1.

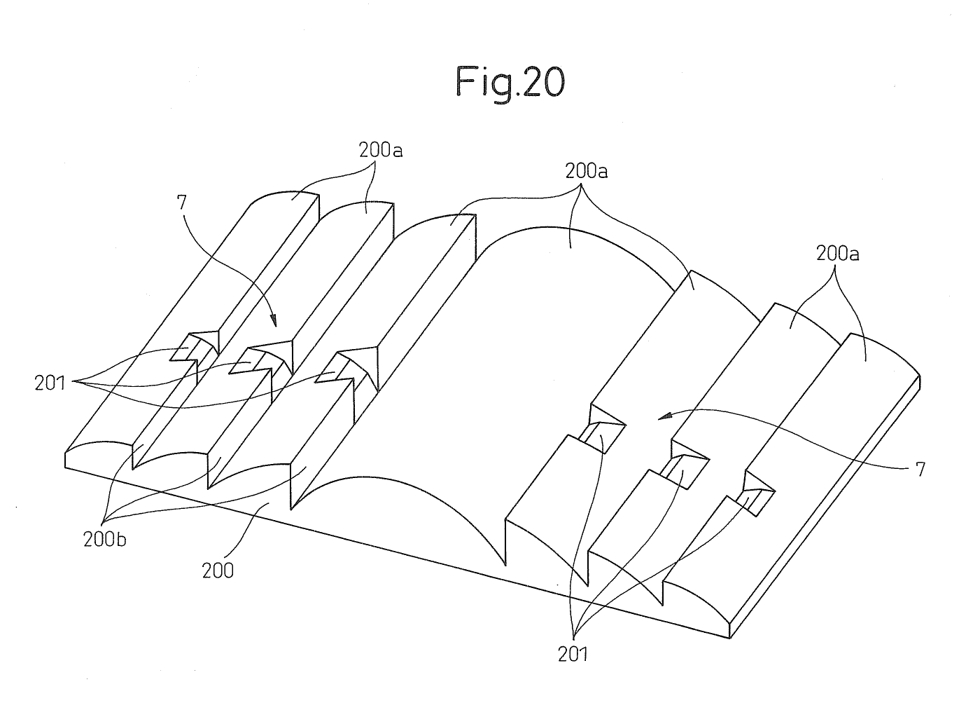

FIG. 20 is a diagram showing a cylindrical Fresnel lens structure 200.

By employing the cylindrical Fresnel lens structure 200 shown in FIG. 20 in place of the Fresnel lens structure 18 in the liquid crystal lens 1, the liquid crystal lens 1 can be used as a cylindrical Fresnel lens.

The cylindrical Fresnel lens structure 200 includes a plurality of segmented lens faces 200a and stepped faces 200b. As a result, when the transparent electrode 12 is formed on the cylindrical Fresnel lens structure 200, it may become difficult to achieve conduction throughout the entire transparent electrode 12. In view of this, a conducting structure 7 is provided that has connecting faces 201 on the respective segmented lenses 200a except the one located in the center.

The connecting faces 201 shown in FIG. 20 are identical in shape to the connecting faces 23 of the conducting structure 2 shown in FIG. 4. However, the shapes of the connecting faces of the alternative conducting structures 3 to 6 may be utilized. Further, the cylindrical Fresnel lens structure 200 shown in FIG. 20 has a total of seven segmented lenses 200a. However, the number of segmented lens faces 200a is not limited to 7, but can be changed variously according to the purpose.

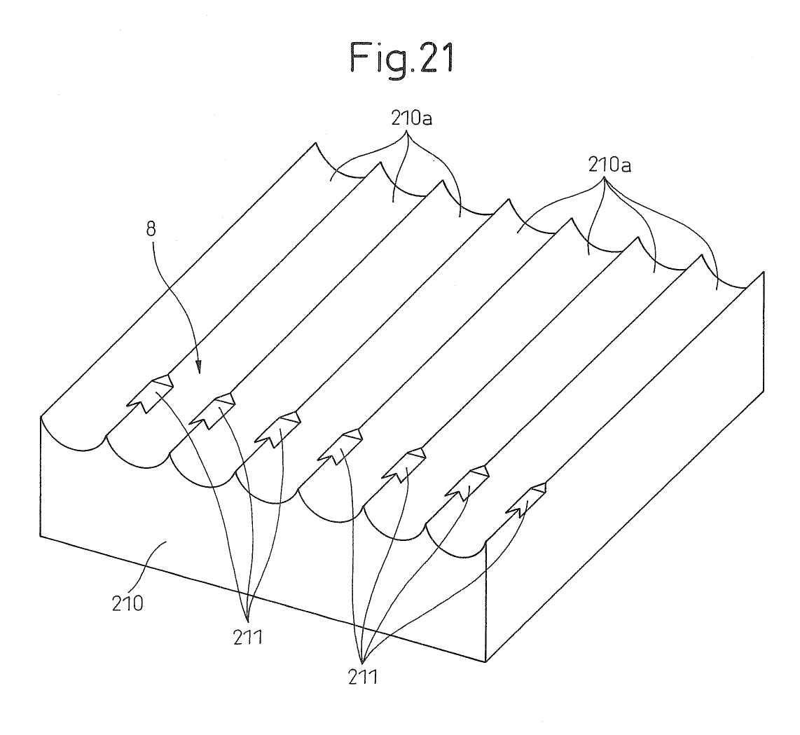

FIG. 21 is a diagram showing a cylindrical lens array structure 210.

By employing the cylindrical lens array structure 210 shown in FIG. 21 in place of the Fresnel lens structure 18 in the liquid crystal lens 1, the liquid crystal lens 1 can be used as a cylindrical lens array (lenticular lens).

The cylindrical lens array structure 210 includes a plurality of segmented lens faces (cylindrical lens faces) 210a. However, since the connecting portion between each segmented lens face 210a is sharp-edged, when the transparent electrode 12 is formed on the cylindrical lens array structure 210, it may become difficult to achieve conduction throughout the entire transparent electrode 12. In view of this, a conducting structure 8 is provided that has connecting faces 211 between the respective segmented lens faces 210a.

The connecting faces 211 in FIG. 21 are each configured to connect between adjacent ones of the segmented lens faces 210a by a single planar face. However, the shapes of the connecting faces of the other conducting structures 2 to 6 may be utilized. Further, the cylindrical lens array structure 210 shown in FIG. 21 has a total of eight segmented lens faces 210a. However, the number of segmented lens faces 210a is not limited to 8, but can be changed variously according to the purpose.

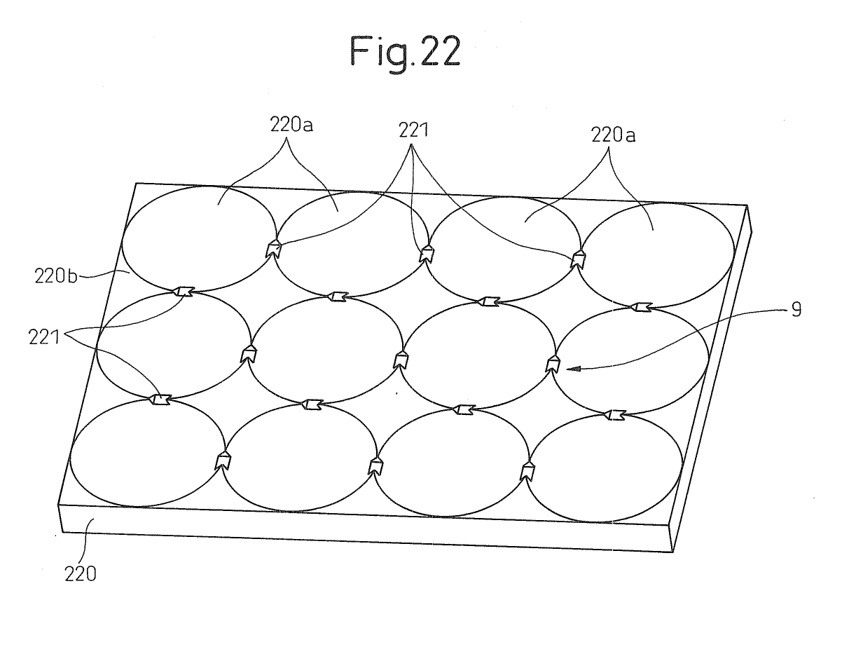

FIG. 22 is a diagram showing a microlens array structure 220.

By employing the microlens array structure 220 shown in FIG. 22 in place of the Fresnel lens structure 18 in the liquid crystal lens 1, the liquid crystal lens 1 can be used as a microlens array (fly's eye lens).

The microlens array structure 220 includes a plurality of segmented lens faces (microlens faces) 220a. However, since the connecting portion between each segmented lens face 220a is sharp-edged, when the transparent electrode 12 is formed on the microlens array structure 220, it may become difficult to achieve conduction throughout the entire transparent electrode 12. In view of this, a conducting structure 9 is provided that has connecting faces 221 between the respective segmented lens faces 220a.

The connecting faces 221 in FIG. 22 are each configured to connect between adjacent ones of the segmented lens faces 220a by a single planar face. However, the shapes of the connecting faces of the other conducting structures 2 to 6 may be utilized. Further, the microlens array structure 220 shown in FIG. 22 has a total of 12 segmented lens faces 220a. However, the number of segmented lens faces 220a is not limited to 12, but can be changed variously according to the purpose.

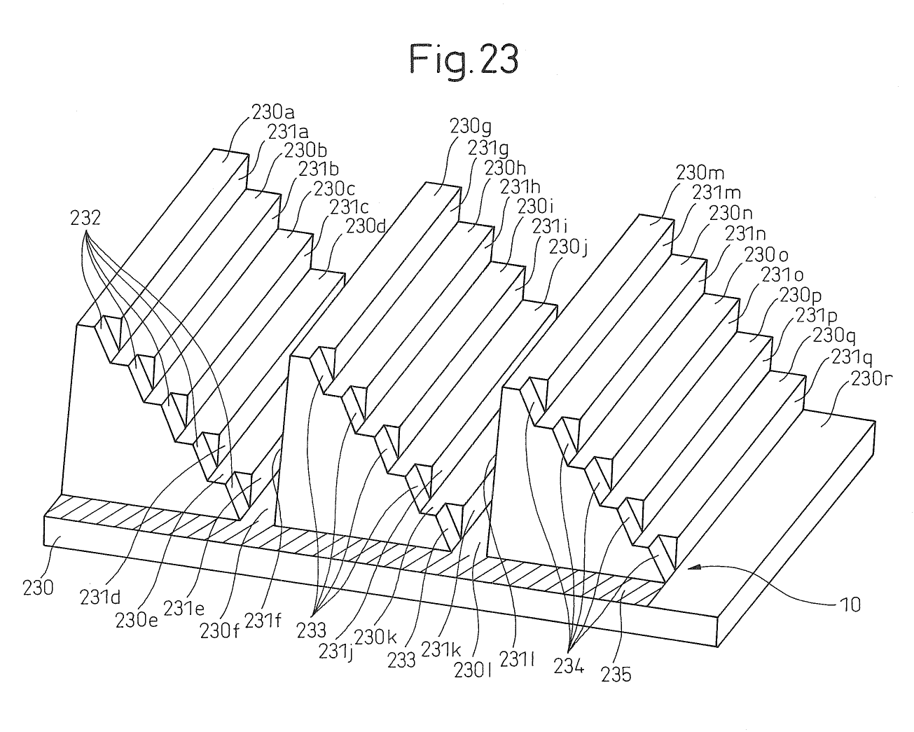

FIG. 23 is a diagram showing a diffraction grating structure 230.

By employing the diffraction grating structure 230 shown in FIG. 23 in place of the Fresnel lens structure 18 in the liquid crystal lens 1, the liquid crystal lens 1 can be used as a diffraction grating.

The diffraction grating structure 230 includes a plurality of segmented lens faces 230a to 230r. However, since the segmented lens faces have stepped faces 231a to 231q, when the transparent electrode 12 is formed on the diffraction grating structure 230, it may become difficult to achieve conduction throughout the entire transparent electrode 12. In view of this, a conducting structure 10 is provided for connecting between the respective segmented lens faces 230.

The conducting structure 10 includes a plurality of first connecting faces 232 provided between the respective segmented lens faces 230a to 230f, a plurality of second connecting faces 233 provided between the respective segmented lens faces 230g to 2301, a plurality of third connecting faces 234 provided between the respective segmented lens faces 230m to 230r, and a fourth connecting face 235 provided for connecting the segmented lens faces 230f, 2301, and 230r.

The first to third connecting faces 232 to 234 in FIG. 23 are each configured to connect between adjacent ones of the slit lens faces 230a to 230r by a single sloping face. However, the shapes of the connecting faces of the other conducting structures 2 to 6 may be utilized. Further, the diffraction grating structure 230 shown in FIG. 23 has a total of 18 segmented lens faces. However, the number of segmented lens faces is not limited to 18, but can be changed variously according to the purpose.

The examples so far have dealt with the Fresnel lens structure (two-dimensional Fresnel lens structure) 18, the cylindrical Fresnel lens structure 200, the cylindrical lens array structure 210, the microlens array structure 220, and the diffraction grating structure 230. However, the present invention can also be applied to other diffractive optical or refractive optical structures or even to a relief pattern holographic optical structure having a more complex structure.

In the electro-optical device according to the present invention, the transparent electrodes formed on the segmented lens faces are electrically connected together by providing the various conducting structures on the various optical structures described above. As a result, the voltage is correctly applied to the liquid crystal layer via the transparent electrodes provided on the various optical structures, and the desired lens characteristics, optical characteristics, and/or aberration correction characteristics, etc., can be obtained.

Further, in the electro-optical device according to the present invention, an electro-optical material having a voltage-controlled refractive index, for example, a solid crystal such as bismuth silicon oxide (BSO) or lithium niobate, or an electro-optical ceramic such as PLZT, may be used instead of the liquid crystal.

1. An electro-optical device comprising:
a first and a second transparent substrate;
an electro-optical material provided between said first and second transparent substrates;
an optical structure provided on said first or second transparent substrate and having a plurality of segmented lens faces;
a conducting structure formed on said optical structure by sacrificing a portion of said optical structure; and
transparent electrodes formed on said plurality of segmented lens faces and said conducting structure, respectively, wherein
said conducting structure includes a connecting face formed by cutting out a portion of said plurality of segmented lens faces or a connecting face formed in a raised shape between said plurality of segmented lens faces in order to connect between adjacent ones of said plurality of segmented lens faces, and
said transparent electrodes formed on said plurality of segmented lens faces are electrically connected together by said transparent electrode formed on said conducting structure.

2. The electro-optical device according to claim 1, wherein said optical structure is a Fresnel lens structure, a cylindrical lens array structure, a microlens array structure, or a diffraction grating structure.

3. (canceled)

4. (canceled)

5. The electro-optical device according to claim 1, wherein said conducting structure includes a first connecting face formed extending across said plurality of segmented lens faces, and a second connecting face connecting between said first connecting face and said plurality of segmented lens faces.

6. The electro-optical device according to claim 5, wherein said optical structure is a Fresnel lens structure, and said first and second connecting faces are formed by cutting out a portion of said Fresnel lens structure.

7. The electro-optical device according to claim 6, wherein said second connecting face is formed in the shape of a ring conforming in shape to said plurality of segmented lens faces.

8. The electro-optical device according to claim 1, wherein said transparent electrodes include an aberration correcting electrode pattern.

9. The electro-optical device according to claim 8, wherein said aberration correcting electrode pattern includes a coma correcting electrode pattern, a spherical aberration correcting electrode pattern, or an astigmatism correcting electrode pattern.

10. The electro-optical device according to claim 1, wherein said electro-optical material is a liquid crystal.
